(19) United States
(12) Patent Application Publication
(10) Pub. No.: US 2026/0065339 A1
(43) Pub. Date: Mar. 5, 2026

(54) AGENTIC MODEL SUPPORTED BY LANGUAGE MODELS TUNED TO INTERACT WITH FULFILLMENT AGENTS ON BEHALF OF USERS OF AN ONLINE SYSTEM

(71) Applicant: Maplebear Inc., San Francisco, CA (US)

(72) Inventors: Mridul Singhai, San Francisco, CA (US); Brent Luna, Oakland, CA (US); Joseph Olivier, San Bruno, CA (US); Reece Boyd, Brentwood, TN (US); Lukasz Czekaj, North Las Vegas, NV (US); Nathan Marks, Toronto (CA)

(21) Appl. No.: 18/818,478

(22) Filed: Aug. 28, 2024

(51) Int. Cl. G06Q 30/0601; G06F 40/35; G06F 40/40

(52) U.S. Cl. CPC G06Q 30/0613; G06F 40/35; G06F 40/40

(57) ABSTRACT

An agentic model supported by language models tuned for interaction with pickers on behalf of users of an online system. Upon receiving a message from a picker related to fulfillment of an order of a user, the online system selects a language model of the agentic model associated with a cluster of users including the user and tuned to have a persona of the user that is common to the cluster of users. The online system requests the language model to generate, based on a prompt input into the language model including the message from the picker, first data related to the user and second data related to the cluster of users, a response to the message on behalf of the user. The online system causes a user interface of the device of the picker and a user interface of a device associated with the user to display the response.

### BACKGROUND

Online systems are widely used for placing online orders so that users of the online systems can perform online purchases of various items (e.g., groceries) offered by sources (e.g., retailers). During order fulfillment, online users may not be available to chat with pickers associated with the online system who fulfill online orders, e.g., when a picker needs to ask about which replacement is preferred or for clarification about how to fulfill an order.

Oftentimes, users are not paying attention to their phones when pickers are actively shopping for their orders. This leads to missed messages, and pickers making assumptions as to what the users want. In such cases, a picker may make a decision that a user does not agree with. The decision made by the picker is not wrong, per se, but just represents a different choice because the picker and the user may have different preferences, judgment, etc. However, users who have bad replacement experiences or bad picker chat experiences churn at a much higher rate.

Therefore, it is desirable to improve a user interface of the online system to enable automatic and accurate representation of users'preferences and judgements for communication with pickers when the users are not available for live communication with the pickers.

### SUMMARY

Embodiments of the present disclosure are directed to an agentic model supported by language models tuned to interact with order fulfillment agents (i.e., pickers) associated with the online system on behalf of users of the online system.

In accordance with one or more aspects of the disclosure, the online system receives, from a device of a picker associated with the online system and via a network, a message related to fulfillment of an order placed by a user of the online system. The online system detects a threshold amount of time elapsed from the reception of the message without the user responding to the message. Responsive to detecting the elapsed threshold amount of time, the online system selects, based on an identification of the user, a large language model (LLM) from a set of LLMs, the selected LLM associated with a cluster of users of the online system including the user and tuned to have a persona of the user that is common to the cluster of users. The online system generates a prompt for input into the selected LLM, the prompt including the message from the picker, first data related to the user, second data related to the cluster of users, and a request for generating a response to the message from the picker. The online system requests the selected LLM to generate, based on the prompt input into the selected LLM, the response to the message from the picker on behalf of the user. The online system causes a user interface of the device of the picker and a user interface of a device associated with the user to display the response to the message.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3A illustrates an example architectural flow diagram of operating an agentic model supported by language models tuned to interact with pickers associated with an online system on behalf of users of the online system, in accordance with one or more embodiments.

FIG. 3B illustrates an example architectural flow diagram of activating an agentic model supported by language models tuned to interact with pickers associated with an online system on behalf of users of the online system, in accordance with one or more embodiments.

FIG. 4 is a flowchart for a method of operating an agentic model supported by language models tuned to interact with pickers associated with an online system on behalf of users of the online system, in accordance with one or more embodiments.

### DETAILED DESCRIPTION

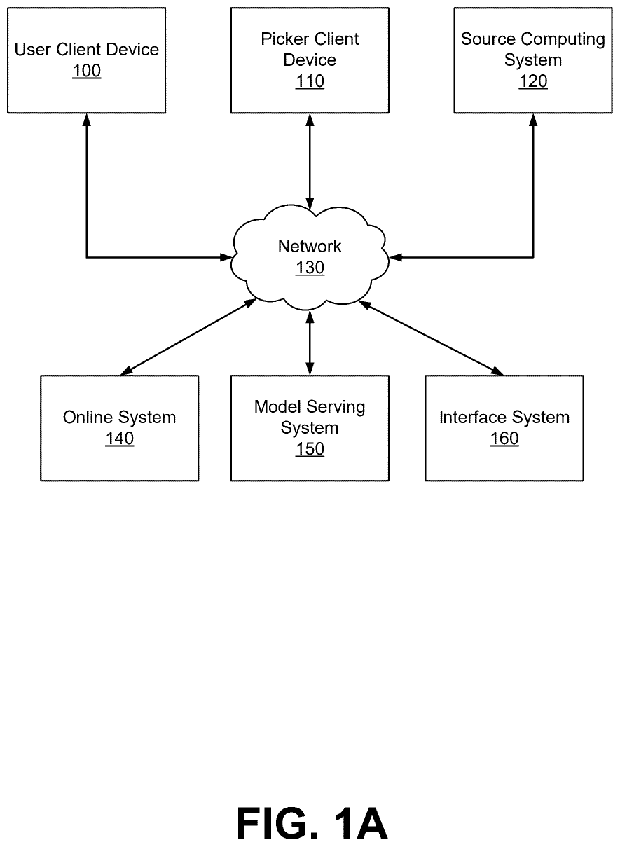

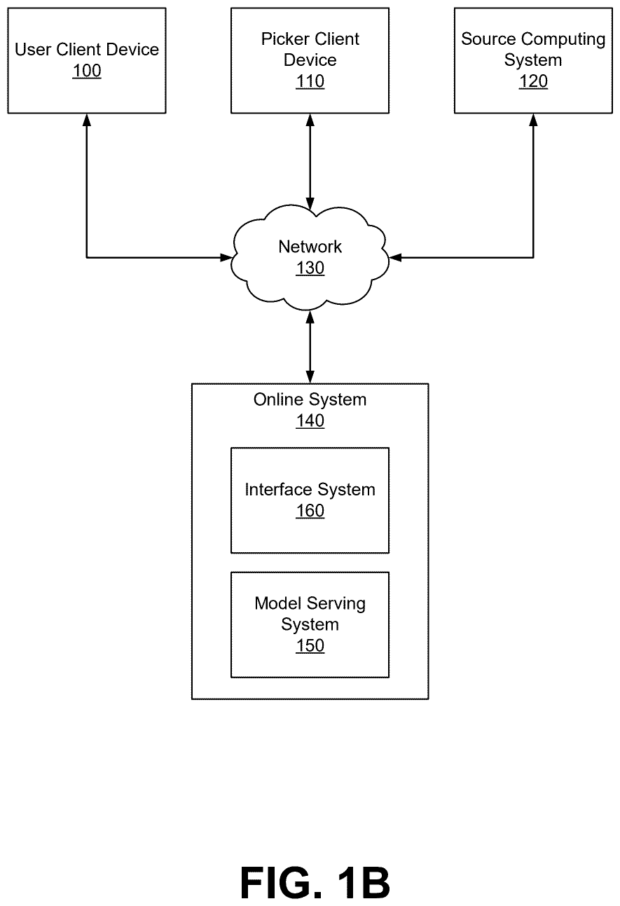

FIG. 1A illustrates an example system environment for an online system 140, in accordance with one or more embodiments. The system environment illustrated in FIG. 1A includes a user client device 100, a picker client device 110, a source computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1A, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140.

The online system 140 dispatches pickers to fulfill orders for users of the online system 140. Occasionally the pickers attempt to contact the users with questions about their orders (e.g., how to replace items that are out of stock), but users are not always available to answer the pickers'questions. To address this issue, the online system 140 trains (or, more generally, tunes) an agentic model (e.g., a set of language models) based on various personas, where users are clustered and mapped to one of the personas. The personas can be used to automate picker-user interactions (e.g., responding to item replacements and handling potential delivery issues) removing the need for the users to actively look at and engage with an application of the online system 140 while their orders are being fulfilled. When a user does not respond to a picker's question in a chat, the online system 140 invokes the agentic model corresponding to the user's persona to provide responses to the picker on the user's behalf. Hence, the online system 140 presented herein integrates the agentic model that can act on behalf of users in order to make pickers'choices much more accurately align with the users'values and preferences.

The model serving system 150 receives requests from the online system 140 to perform tasks using machine-learning models. The tasks include, but are not limited to, natural language processing (NLP) tasks, audio processing tasks, image processing tasks, video processing tasks, and the like. In one or more embodiments, the machine-learning models deployed by the model serving system 150 are language models configured to perform one or more NLP tasks. The NLP tasks include, but are not limited to, text generation, query processing, machine translation, chatbots, and the like. In one or more embodiments, a language model of the model serving system 150 is configured as a transformer neural network architecture (i.e., a transformer model). Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learning model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM, the LLM is able to perform various tasks and synthesize and formulate output responses based on information extracted from the training data.

In one or more embodiments, when the machine-learning model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In one or more other embodiments, the transformer architecture may have an encoder-decoder architecture and includes a set of encoders coupled to a set of decoders. An encoder or decoder may include one or more attention operations.

While a LLM with a transformer-based architecture is described in one or more embodiments, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

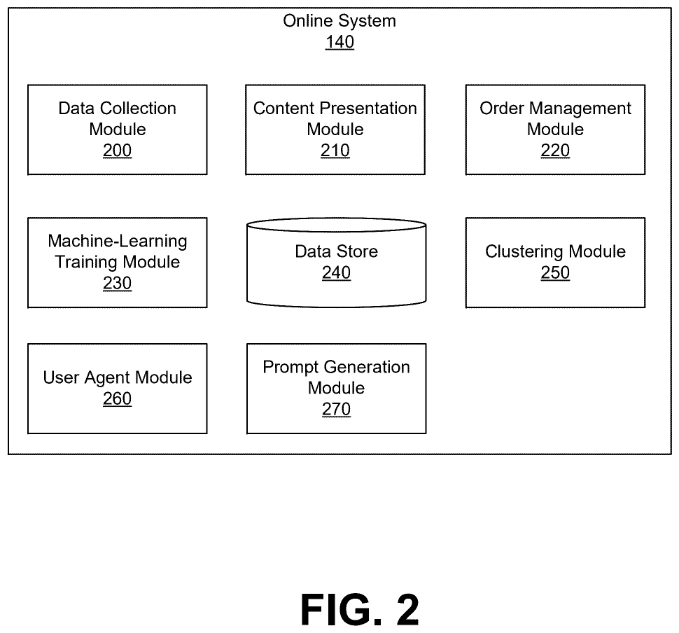

The online system 140 may employ multiple LLMs of the model serving system 150 to implement the agentic model. The LLMs of the model serving system 150 may be used for receiving multi-modal inputs from a chat interface of the online system 140 to allow pickers to either write, speak, or send pictures in a chatroom setting. The online system 140 may prepare (e.g., via a prompt generation module 270 in FIG. 2) a prompt for input to the LLMs. The prompt may include multi-modal inputs related to questions from pickers about fulfillment of users'orders, such as textual messages, screenshots of unanswered SMS messages previously sent to users, voice recording of pickers'questions, images of potential replacement items, etc.

In one or more embodiments, each LLM of the set of LLMs of the model serving system 150 is tuned to have a different persona. Hence, as the set of LLMs of the model serving system 150 integrates the agentic model, the agentic model supports different personas. Each LLM of the agentic model may generate a response to the prompt in accordance with a specific persona based on execution of the machine-learning model using the prompt. The response may include a message for a picker with an answer to a specific question from the picker included in the prompt. The LLM may generate the response in accordance with the specific persona of a user whose order is being fulfilled by the picker. The LLM may have access to swaths of user data to determine if an automatic reply to a picker's question is appropriate, and, if so, the LLM responds to the picker in accordance with the user's persona invoked by the LLM. In such cases, the online system 140 may import the response from the model serving system 150 and use the response to populate a user interface of the picker client device 110. When the LLM determines that the automatic reply to the picker's question is not appropriate, the LLM may pass a picker's message to the user for displaying at a user interface of the user client device 100.

In one or more embodiments, the task for the model serving system 150 is based on knowledge of the online system 140 that is fed to the machine-learning model of the model serving system 150, rather than relying on general knowledge encoded in the model weights of the model. Thus, one objective may be to perform various types of queries on the external data in order to perform any task that the machine-learning model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 150 and synthesizes a response to the query on the external data. While the online system 140 can generate a prompt using the external data as context, often times, the amount of information in the external data exceeds prompt size limitations configured by the machine-learning language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a user client device 100, a picker client device 110, a source computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140. The online system 140 is described in further detail below with regards to FIG. 2.

FIG. 2 illustrates an example system architecture for the online system 140, in accordance with some embodiments. The system architecture illustrated in FIG. 2 includes a data collection module 200, a content presentation module 210, an order management module 220, a machine-learning training module 230, a data store 240, a clustering module 250, a user agent module 260, and a prompt generation module 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from the source computing system 120, the picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

With respect to the machine-learning models hosted by the model serving system 150, the machine-learning models may already be trained by a separate entity from the entity responsible for the online system 140. In one or more other embodiments, when the model serving system 150 is included in the online system 140, the machine-learning training module 230 may further train parameters of the machine-learning model based on data specific to the online system 140 stored in the data store 240. As an example, the machine-learning training module 230 may obtain a pre-trained transformer language model and further fine tune the parameters of the transformer language model using training data stored in the data store 240. The machine-learning training module 230 may provide the transformer language model to the model serving system 150 for deployment.

The clustering module 250 may cluster a collection of users of the online system 140 into a set of clusters. The clustering module 250 may utilize various input parameters, such as past user chats, replacement history, satisfaction, etc. to place each user of the collection of users into a corresponding cluster of the set of clusters. The clustering module 250 may generate, based on the input parameters, embeddings for each user of the collection of users, and then place the collection of users into the set of clusters based on the embeddings. In one or more embodiments, the clustering module 250 applies the nearest neighbor clustering to the input parameters to place the collection of users into the set of clusters. Alternatively, the clustering module 250 may deploy the two-tower model to the input parameters to generate embeddings for the collection of users, and then place each user into a corresponding cluster based on the generated embeddings.

The user agent module 260 may invoke a corresponding language model (e.g., LLM) of the agentic model that can appear at a chat interface as a participant in the conversation with a picker associated with the online system 140 on behalf of a specific user of the online system 140. The chat interface may correspond to a user interface of the picker client device 110 and/or a user interface of the user client device 100. In one or more embodiments, the user agent module 260 accesses a corresponding language model (e.g., LLM of the model serving system 150) that is tuned to have a particular user persona in accordance with a cluster of users to which the specific user belongs. Multiple language models (e.g., LLMs) of the agentic model may be tuned (e.g., via the model serving system 150) for different clusters (or cohorts, types, etc.) of users. Hence, each LLM of the agentic model may be tuned for a respective cluster of users. The model serving system 150 may utilize the same information previously used to place users into a specific cluster for tuning an LLM of the agentic model to have a persona corresponding to that specific cluster of users. The model serving system 150 may tune the LLM to have the persona of the cohort of users assigned to the specific cluster, based on information related to the users that were assigned to that specific cluster. Furthermore, by clustering users into a particular cluster, cold start data may be generated for tuning an LLM for that user's individual persona.

The clustering module 250 may group users of the online system 140 into clusters (or groups) that are based on markers such as food preferences, order sizes, and chat interactions between users and pickers. The agentic model implemented as multiple LLMs of the model serving system 150 that emulate different users'personas may be then pre-tuned on these user clusters and aggregated data at the chat and order levels.

Each LLM of the agentic model that corresponds to a respective user's persona and a cluster of users may be pre-tuned (e.g., via the model serving system 150) on historical user order data, user-picker chat data, user cluster data, etc. Personalization of each LLM of the agentic model may come into play when a user places an order. In addition to the aggregated data, each LLM of the agentic model may then be tuned on the user-specific data, such as their own past orders as well as past user's chats with pickers. Each LLM of the agentic model may weigh the user-specific data more heavily but will also rely on aggregated data associated with a specific cluster of users to help answer with more nuance which may not be achievable with smaller datasets related only to an individual user.

After the user agent module 260 invokes a corresponding LLM (e.g., LLM of the model serving system 150) of the agentic model that has a specific user's persona, the prompt generation module 270 may prompt the invoked LLM to generate an answer to a specific picker's question. The prompt generation module 270 may further generate a prompt for input into the invoked LLM. In addition to the picker's question (e.g., text data, speech, image, etc.), the prompt may include a set of inputs. The prompt generation module 270 may further include a request into the prompt to ask the invoked LLM to generate the answer to the specific picker's question.

In providing the set of inputs to the invoked LLM of the agentic model, the prompt generation module 270 may provide data from the user's own chats and past orders, i.e., user specific chat data and order data. The user specific data may inform the invoked LLM on how to respond to the picker's question, and what the very specific food and serving preferences of a user are. The order data (including specific user order data as well as the aggregation of user cluster order data) may additionally include replacement satisfaction data which would inform the invoked LLM on best match replacements when items are unexpectedly out of stock.

In one or more embodiments, the agentic model implemented as the set of LLMs tuned to have different personas may be given access (e.g., via the prompt generation module 270 or some other module of the online system 140) to accounts of the collection of users of the online system 140, including content of their previous orders, content of their previous chat interactions, feedback related to orders containing replacements, etc. Additionally, the agentic model may be given access (e.g., via the prompt generation module 270 or some other module of the online system 140) to public and private application programming interfaces (APIs) of the online system 140, such as the availability model of the online system 140, the replacement model of the online system 140, aggregated order data based on each cluster of users, aggregated user-picker chat data based on each cluster of users, etc.

When fulfilling a user's order, and if a picker associated with the online system 140 sends a message in a chat interface (e.g., user interface of the picker client device 110) without the user responding within a threshold amount of time, then the following mechanism may be applied. The user agent module 260 may invoke a user's assigned LLM of the agentic model that is tuned to have a corresponding user's persona. The prompt generation model 270 may then prompt the invoked LLM with a picker's question and a request the invoked LLM to respond to the picker's question from the perspective of the corresponding user's persona. Based on the prompt input into the invoked LLM, the invoked LLM (i.e., the user's assigned portion of the agentic model) may generate a response that includes an answer to the picker's question on behalf of the user. The response provided by the invoked LLM may be imported to the online system 140, e.g., via the user agent module 260, and the user agent module 260 may pass the imported response to the content presentation module 210. The content presentation module 210 may then cause a user interface of the user client device 100 and a user interface of the picker client device 110 to display a message that corresponds to the answer to the picker's question so that both the user and the picker can see the machine-generated answer.

The agentic model including the set of LLMs each assigned to a different cluster of users may be constrained with four predetermined actions that can be taken. First, the agentic model may reply, when appropriate, to a picker associated with the online system who sends a chat message to a user of the online system 140. Second, the agentic model may pass a picker's message to a user, when appropriate. Third, the agentic model may approve or deny a picker's request for a replacement item. And fourth, the agentic model may approve or deny a picker's request for a refund if an item is out of stock.

In one or more embodiments, the agentic model determines that it is not appropriate for the agentic model to reply to a picker's message. Then, the agentic model may send an original message from the picker to the user. In such cases, the user agent module 260 may pass the original picker's message to the content presentation module 210, and the content presentation module 210 may then cause a user interface of the user client device 100 to display the original picker's message. However, if the agentic model determines that replying to the picker's message is appropriate, the agentic model may generate a response to the picker's message and may reply to the picker on the user's behalf (or automatically approve/deny a request). If the agentic model determines that a response is appropriate, the agentic model may send a request to a chat API of the online system 140 (e.g., controlled by the user agent module 260 or some other module of the online system 140) to respond on the user's behalf with the machine-generated reply. In such cases, the user agent module 260 may import the response from the agentic model (e.g., corresponding LLM of the model serving system 150) and pass the response to the content presentation module 210. The content presentation module 210 may then cause the user interface of the picker client device 110 as well as the user interface of the user client device 100 to display the response generated by the agentic model.

In one or more embodiments, a corresponding LLM of the agentic model (i.e., the LLM that corresponds to the user's persona) is re-tuned (e.g., via the model serving system 150) based on the user's satisfaction with the result of the instruction generated by the corresponding LLM of the agentic model. A user's response provided via a user interface of the user client device 100 may represent a strong signal for re-tuning of that LLM of the agentic model. Thus, each LLM of the agentic model may re-tuned (e.g., via the model serving system 150) based on Reinforcement Learning from Human Feedback (RLHF), i.e., the human feedback can be critical for the agentic model to operate accurately. As the agentic model is utilized for communication with pickers on behalf of users, the model serving system 150 (and, optionally, the online system 140) can observe in real-time how the agentic model performs. When users in a specific segment respond well to a particular response generated by the agentic model, that response may be positively reinforced during re-tuning of the agentic model via the model serving system 150. Likewise, when users respond poorly to a response generated by the agentic model, that response may be negatively reinforced during re-tuning of the agentic model via the model serving system 150.

Additionally or alternatively, during the re-tuning of a specific LLM of the agentic model, the model serving system 150 may adjust an entropy of the LLM to increase exploration of different answers to picker's questions, as well as to get more training examples for re-tuning of the LLM. Conversely, when the LLM operates accurately, the model serving system 150 may reduce the entropy of the LLM, thus achieving the exploration-exploitation balance. Additionally or alternatively, each LLM of the agentic model may be able to re-tune other LLMs of the agentic model, e.g., based on responses to pickers'chats generated by that LLM.

In one or more embodiments, when importing a response from the agentic model (e.g., a corresponding LLM of the model serving system 150 having a specific user's persona), the user agent module 260 may introduce variation into the response in order to simulate an experiment with an unlikely or non-optimal response to a picker's question. The user agent module 260 may then gather data with unexpectedly positive results (i.e., positive feedback from users) when unlikely or non-optimal responses are provided to pickers. The data with unexpectedly positive results may be then passed to the model serving system 150 and utilized for re-tuning of one or more LLMs of the agentic model.

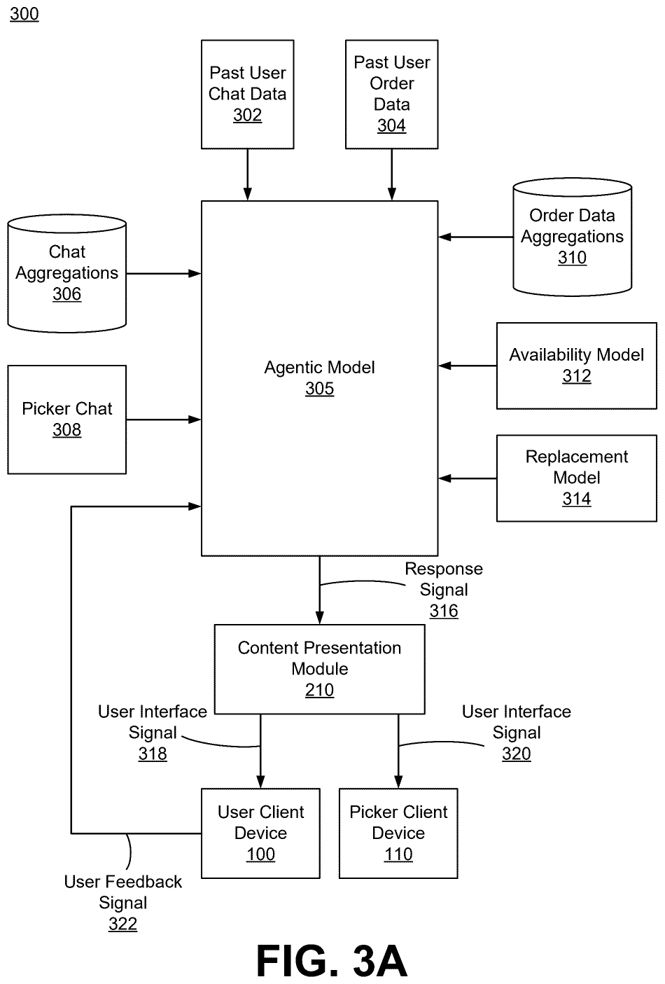

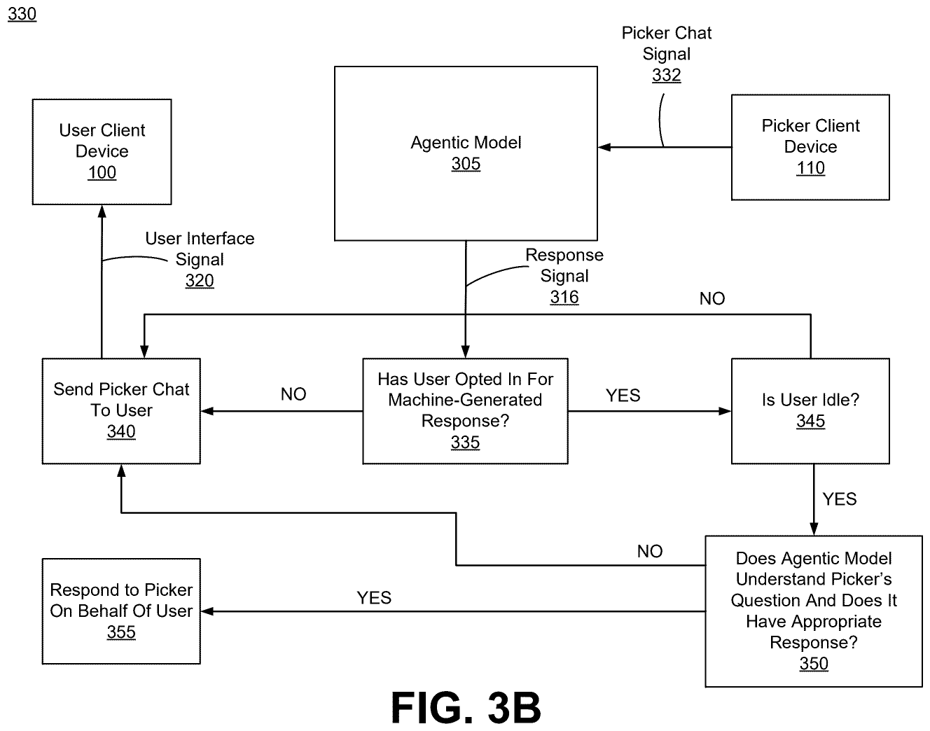

FIG. 3A illustrates an example architectural flow diagram 300 of operating an agentic model 305 supported by a set of language models (e.g., LLMs of the model serving system 150) to interact with pickers associated with the online system 140 on behalf of users of the online system 140, in accordance with one or more embodiments. The agentic model 305 may include a set of LLMs, where each LLM in the set of LLMs may be invoked for a corresponding cluster of users of the online system 140 for emulating a corresponding user's persona. The agentic model 305 may be part of the model serving system 150.

After receiving a picker's chat 308 from the picker client device 110 in relation to an order placed by a specific user of the online system 140 and invoking an LLM of the agentic model 305 that corresponds to that specific user, the online system 140 may provide various inputs to the LLM of the agentic model 305, e.g., via the prompt generation module 270. In providing the inputs to the LLM of the agentic model 305, the prompt generation module 270 may provide past user chat data 302, past user order data 304, chat aggregations 306 associated with users of a corresponding cluster of users, the picker chat 308, order data aggregations 310 associated with users of the corresponding cluster of users, an output of an availability model 312 (e.g., machine-learning model) including information about availability of certain items at a source associated with the online system 140, and/or an output of a replacement model 314 (e.g., machine-learning model) including information about candidate items for replacement of a specific item (e.g., if replacement is requested by the picker). Some additional inputs not shown in FIG. 3A may be further provided to the agentic model 305.

In providing the past user chat data 302 to the agentic model 305, the prompt generation module 270 may provide historic user's chat data exchanged between the user and pickers associated with the online system 140. The past user chat data 302 may be received over time from the user client device 100 via the network 130 and stored at a user catalog database of the data store 240. The prompt generation module 270 may then retrieve the past user chat data 302 from the data store 240.

In providing the past user order data 304 to the agentic model 305, the prompt generation module 270 may provide data with information about user's historic online orders. The past user order data 304 may be received over time from the user client device 100 via the network 130 and stored at the user catalog database of the data store 240. The prompt generation module 270 may then retrieve the past user order data 304 from the data store 240.

In providing the chat aggregations 306 to the agentic model 305, the prompt generation module 270 may provide historic chat data exchanged between a specific cluster of users (e.g., group of users, cohort of users, type of users, etc.) whose LLM of the agentic model 305 has been invoked and pickers associated with the online system 140. The chat aggregations 306 may be formed by aggregating chat data received over time from user client devices 100 via the network 130 and stored at the user catalog database of the data store 240. The prompt generation module 270 may then retrieve the chat aggregations 306 from the data store 240.

In providing the order data aggregations 310 to the agentic model 305, the prompt generation module 270 may provide data with information about historic orders placed at the online system 140 by the cluster of users and the pickers. The order data aggregations 310 may be formed by aggregating order data received over time from user client devices 100 via the network 130 and stored at the user catalog database of the data store 240. The prompt generation module 270 may then retrieve the order data aggregations 310 from the data store 240.

Based on the inputs to the corresponding LLM of the agentic model 305 that is tuned to have the specific user's persona, the agentic model 305 may generate a response signal 316 including a machine-generated response to the picker chat 308. The agentic model 305 may then pass the response signal 316 to the content presentation module 210. The content presentation module 210 may utilize the response signal 316 to generate a user interface signal 318 for the user client device 100 causing a user interface of the user client device 100 to display the machine-generated response to the picker chat 308. Similarly, the content presentation module 210 may also use the response signal 316 to generate a user interface signal 320 for the picker client device 110 causing a user interface of the picker client device 110 to display the machine-generated response to the picker chat 308. In one or more embodiments, the machine-generated response to the picker chat 308 may include a response to a specific picker's question in relation to the fulfillment of the order. Alternatively, the machine-generated response to the picker chat 308 may include approval or denial of the picker's request for a replacement of an item requested by the user that is out of stock. Alternatively, the machine-generated response to the picker chat 308 may include approval or denial of picker's request for refund. Additionally, based on the response signal 316, the user agent module 260 (or some other module of the online system 140) may set replacement preferences for the user, e.g., in the user catalog database of the data store 240.

In one or more embodiments, the user may provide feedback in relation to the machine-generated response to the picker chat 308 via the user interface of the user client device 100, wherein the feedback includes information about a user's level of satisfaction about the machine-generated response. The user's feedback may be recorded at the user client device 100 as a user feedback signal 322. The user feedback signal 322 may be then imported via the network 130 to the model serving system 150 and used for the RLHF based re-tuning of the corresponding LLM of the agentic model 305.

FIG. 3B illustrates an example architectural flow diagram 330 of activating the agentic model 305 supported by language models to interact with pickers associated with the online system 140 on behalf of users of the online system 140, in accordance with one or more embodiments. The agentic model 305 may be integrated between a user of the online system 140 and a picker associated with the online system 140 who fulfills an online order placed by the user. When the picker sends a message via a chat interface (e.g., user interface of the picker client device 110), the agentic model 305 may intercept a picker chat signal 332 including the sent message and initiate a process of determining whether to respond to the picker's message on the user's behalf. Note that the picker chat signal 332 may include information about the picker chat 308 in FIG. 3A.

Once the agentic model generates the response signal 316 including the machine-generated response to the picker's message (e.g., picker chat) included in the picker chat signal 332, the user agent module 260 (or some other module of the online system 140) may check, at 335, whether the user opted in for a machine-generated response. If the user did not opt in for the machine-generated response, the user agent module 260 may decide, at 340, that the picker chat should be sent to the user instead of providing the machine-generated response. In such cases, the content presentation module 210 may generate the user interface signal 320 causing the user interface of the user client device 100 to display the picker's message (e.g., original picker chat).

In contrast, if the user opted in for the machine-generated response, then the user agent module 260 may determine, at 345, whether the user is idle, e.g., via communication with the user client device 100. If the user is not idle (e.g., the user is online and checking status of the placed order), then the user agent module 260 may again decide, at 340, that the picker chat should be sent to the user instead of generating the machine-generated response. If the user is idle (e.g., the user is not online and is not checking status of the order), then the user agent module 260 may determine, at 350, whether the agentic model 305 understands the picker's question and whether the agentic model 305 has an appropriate machine-generated response. If the agentic model 305 does not understand the picker's question and/or does not have the appropriate machine-generated response, then the user agent module 260 may again decide, at 340, that the picker chat including the picker's question should be sent to the user instead of providing the machine-generated response. However, if the agentic model 305 understands the picker's question and has the appropriate machine-generated response, the user agent module 260 may decide, at 355, that the machine-generated response to the picker's question should be sent to the picker via the user interface of the picker client device 110.

It should be noted that the replacement model 314 only determines which pairwise item should replace an out-of-stock item requested as part of a user's order. However, the replacement model 314 may not identify what should be done when the picker suggests a specific item replacement. For example, the replacement model 314 may identify that Honey Nut Cheerios is the best replacement for Cheerios due to availability constraints as well as similarity scores. However, a different machine-learning approach is required when the picker poses a question like “It looks like the store has no Cheerios, do you want Honey Nut Cheerios instead?” The ability to automate this interaction without a simple yes or no response to the picker's question is achieved by the agentic model 305 supported by the set of LLMs. Additionally, the agentic model 305 has the ability to infer a user's “true” preference by searching through order history and user cluster data. For example, the agentic model 305 may look at the user's past order history and realize that the user always purchases low sugar cereals. Hence, instead of just answering “yes” to the replacement suggestion, the agentic model 305 may reply with, e.g., “Actually, I'd prefer something with not a lot of sugar in it, can you get me Corn Flakes instead?”

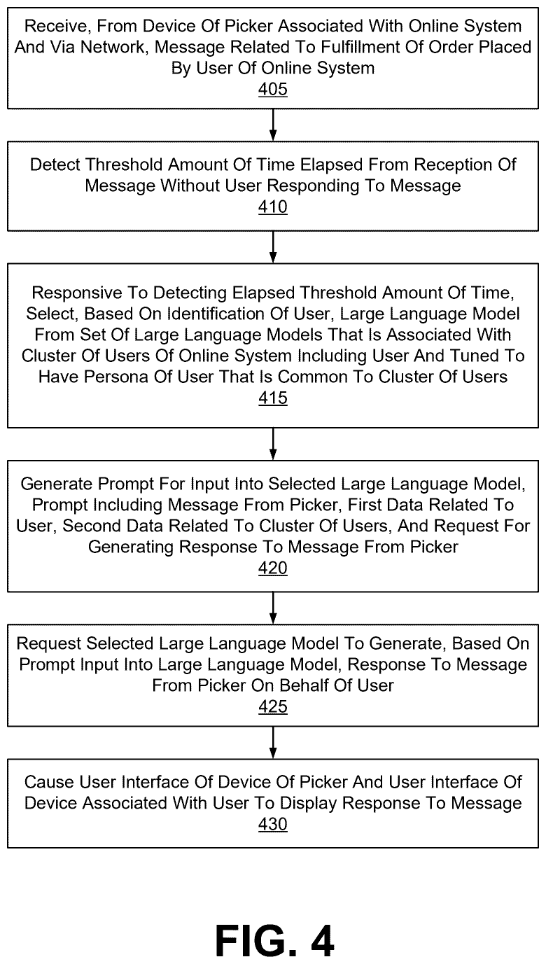

FIG. 4 is a flowchart for a method of operating an agentic model supported by language models (e.g., LLMs) tuned to interact with pickers associated with an online system on behalf of users of the online system, in accordance with one or more embodiments. Alternative embodiments may include more, fewer, or different steps from those illustrated in FIG. 4, and the steps may be performed in a different order from that illustrated in FIG. 4. These steps may be performed by an online system (e.g., the online system 140). Additionally, each of these steps may be performed automatically by the online system without human intervention.

The online system 140 receives 405 (e.g., via the user agent module 260), from a device of a picker (e.g., the picker client device 110) associated with the online system 140 and via a network (e.g., the network 130), a message related to fulfillment of an order placed by a user of the online system 140. The online system 140 detects 410 (e.g., via the user agent module 260) a threshold amount of time elapsed from the reception of the message without the user responding to the message. Responsive to detecting the elapsed threshold amount of time, the online system 140 selects 415 (e.g., via the user agent module 260), based on an identification of the user, an LLM from a set of LLMs (e.g., LLMs of the model serving system 150) that is associated with a cluster of users of the online system 140 including the user and tuned to have a persona of the user that is common to the cluster of users.

The online system 140 may place (e.g., via the clustering module 250), based on at least one of chat data exchanged over time between the device associated with the user and one or more devices of one or more pickers associated with the online system 140, information about item replacements associated with the user, or information about satisfaction of the user with a collection of pickers associated with the online system 140, the user into the cluster of users. The online system 140 may also generate (e.g., via the clustering module 250) the identification of the user placed into the cluster of users.

In one or more embodiments, the online system 140 creates the cluster of users by applying (e.g., via the clustering module 250) nearest neighbor clustering to data associated with a collection of users of the online system 140. The online system 140 may also generate (e.g., via the clustering module 250) an identification of each user of the collection of users that is placed to the cluster of users.

The online system 140 generates 420 (e.g., via the prompt generation module 270) a prompt for input into the selected LLM, the prompt including the message from the picker, first data related to the user, second data related to the cluster of users, and a request for generating a response to the message from the picker. The online system 140 may receive, over time from the device associated with the user and via the network, chat data exchanged between the device associated with the user and one or more devices of one or more pickers (e.g., one or more picker client devices 110) associated with the online system 140. Additionally or alternatively, the online system 140 may receive, over time from the device associated with the user and via the network, order data with information about a plurality of orders placed by the user at the online system 140. The online system 140 may include (e.g., via the prompt generation module 270) the chat data and the order data into the prompt for input into the selected LLM as the first data related to the user.

Additionally, the online system 140 may retrieve (e.g., via the prompt generation module 270), from a database of the online system 140 (e.g., the data store 240), aggregated chat data exchanged over time between a plurality of devices associated with the cluster of users (e.g., user client devices 100) and a plurality of devices of pickers (e.g., picker client devices 110) associated with the online system 140. Additionally or alternatively, the online system 140 may retrieve (e.g., via the prompt generation module 270), from the database, aggregated order data with information about a plurality of orders placed over time by the cluster of users at the online system. The online system 140 may then include the aggregated chat data and the aggregated order data into the prompt for input into the selected LLM as the second data related to the cluster of users.

The online system 140 may tune (e.g., via the model serving system 150), based on at least one of chat data exchanged over time between the device associated with the user and one or more devices of one or more pickers associated with the online system 140 or order data with information about a plurality of orders placed by the user at the online system 140, the LLM to have the persona of the user. Alternatively or additionally, the online system 140 may tune (e.g., via the model serving system 150), based on at least one of aggregated chat data exchanged over time between a plurality of devices associated with the cluster of users and a plurality of devices of pickers associated with the online system 140 or aggregated order data with information about a plurality of orders placed over time by the cluster of users at the online system 140, the LLM to have the persona of the user.

The online system 140 requests 425 (e.g., via the prompt generation module 270) the LLM to generate, based on the prompt input into the selected LLM, the response to the message from the picker on behalf of the user. The online system 140 causes 430 (e.g., via the content presentation module 210) a user interface of the device of the picker and a user interface of a device associated with the user (e.g., the user client device 100) to display the response to the message.

The online system 140 may receive (e.g., at the model serving system 150), from the device associated with the user and via the network, data with information about a level of satisfaction of the user in relation to the response to the message from the picker generated by the selected LLM on behalf of the user. The online system 140 may re-tune (e.g., via the model serving system 150) the selected LLM based at least in part on the received data.

The online system 140 may receive (e.g., at the model serving system 150), from the device associated with the user and via the network, a message entered by the user via the user interface of the device associated with the user upon viewing the response generated by the selected LLM. The online system 140 may re-tune (e.g., via the model serving system 150) the selected LLM based at least in part on the received message entered by the user.

The online system 140 may introduce (e.g., via the user agent module 250) a variation to the response generated by the selected LLM to generate a modified response to the message from the picker on behalf of the user. The online system 140 may cause (e.g., via the content presentation module 210) the user interface of the device associated with the user to further display the modified response. The online system 140 may receive (e.g., at the model serving system 150), from the device associated with the user and via the network, a message entered by the user via the user interface of the device associated with the user upon viewing the modified response. The online system 140 may re-tune (e.g., via the model serving system 150) the selected LLM based at least in part on the received message entered by the user.

Embodiments of the present disclosure are directed to the online system 140 with an agentic model supported by language models for interaction with pickers associated with the online system 140 on behalf of users of the online system 140. Each language model of a set of language models of the agentic model may be tuned to operate as an agentic chatbot for clusters of users of the online system 140, where users were assigned to clusters based on their historical interactions with the online system 140. Each language model of the agentic model may be tuned based on previous chats and users'satisfactions with actions (e.g., replacements) taken by the online system 140.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, from a device of a picker associated with an online system and via a network, a message related to fulfillment of an order placed by a user of the online system;
detecting a threshold amount of time elapsed from the reception of the message without the user responding to the message;
responsive to detecting the elapsed threshold amount of time, selecting, based on an identification of the user, a large language model (LLM) from a set of LLMs, the selected LLM associated with a cluster of users of the online system including the user and tuned to have a persona of the user that is common to the cluster of users;
generating a prompt for input into the selected LLM, the prompt including the message from the picker, first data related to the user, second data related to the cluster of users, and a request for generating a response to the message from the picker;
requesting the selected LLM to generate, based on the prompt input into the selected LLM, the response to the message from the picker on behalf of the user; and
causing a user interface of the device of the picker and a user interface of a device associated with the user to display the response to the message.

2. The method of claim 1, wherein generating the prompt for input into the selected LLM comprises:
receiving, over time from the device associated with the user and via the network, chat data exchanged between the device associated with the user and one or more devices of one or more pickers associated with the online system;
receiving, over time from the device associated with the user and via the network, order data with information about a plurality of orders placed by the user at the online system; and
including the chat data and the order data into the prompt for input into the selected LLM as the first data related to the user.

3. The method of claim 1, wherein generating the prompt for input into the selected LLM comprises:
retrieving, from a database of the online system, aggregated chat data exchanged over time between a plurality of devices associated with the cluster of users and a plurality of devices of pickers associated with the online system;
retrieving, from the database, aggregated order data with information about a plurality of orders placed over time by the cluster of users at the online system; and
including the aggregated chat data and the aggregated order data into the prompt for input into the selected LLM as the second data related to the cluster of users.

4. The method of claim 1, further comprising:
placing, based on at least one of chat data exchanged over time between the device associated with the user and one or more devices of one or more pickers associated with the online system, information about item replacements associated with the user, or information about satisfaction of the user with a collection of pickers associated with the online system, the user into the cluster of users; and
generating the identification of the user placed into the cluster of users.

5. The method of claim 1, further comprising:
creating the cluster of users by applying nearest neighbor clustering to data associated with a collection of users of the online system; and
generating an identification of each user of the collection of users that is placed to the cluster of users.

6. The method of claim 1, further comprising:
tuning, based on at least one of chat data exchanged over time between the device associated with the user and one or more devices of one or more pickers associated with the online system or order data with information about a plurality of orders placed by the user at the online system, the LLM to have the persona of the user.

7. The method of claim 1, further comprising:
tuning, based on at least one of aggregated chat data exchanged over time between a plurality of devices associated with the cluster of users and a plurality of devices of pickers associated with the online system or aggregated order data with information about a plurality of orders placed over time by the cluster of users at the online system, the LLM to have the persona of the user.

8. The method of claim 1, further comprising:
receiving, from the device associated with the user and via the network, data with information about a level of satisfaction of the user in relation to the response to the message from the picker generated by the selected LLM on behalf of the user; and
re-tuning the selected LLM based at least in part on the received data.

9. The method of claim 1, further comprising:
receiving, from the device associated with the user and via the network, a message entered by the user via the user interface of the device associated with the user upon viewing the response generated by the selected LLM; and
re-tuning the selected LLM based at least in part on the received message entered by the user.

10. The method of claim 1, further comprising:
introducing a variation to the response generated by the selected LLM to generate a modified response to the message from the picker on behalf of the user;
causing the user interface of the device associated with the user to further display the modified response;
receiving, from the device associated with the user and via the network, a message entered by the user via the user interface of the device associated with the user upon viewing the modified response; and
re-tuning the selected LLM based at least in part on the received message entered by the user.

11. A computer program product comprising a non-transitory computer readable storage medium having instructions encoded thereon that, when executed by a processor, cause the processor to perform steps comprising:
receiving, from a device of a picker associated with an online system and via a network, a message related to fulfillment of an order placed by a user of the online system;
detecting a threshold amount of time elapsed from the reception of the message without the user responding to the message;
responsive to detecting the elapsed threshold amount of time, selecting, based on an identification of the user, a large language model (LLM) from a set of LLMs, the selected LLM associated with a cluster of users of the online system including the user and tuned to have a persona of the user that is common to the cluster of users;
generating a prompt for input into the selected LLM, the prompt including the message from the picker, first data related to the user, second data related to the cluster of users, and a request for generating a response to the message from the picker;
requesting the selected LLM to generate, based on the prompt input into the selected LLM, the response to the message from the picker on behalf of the user; and
causing a user interface of the device of the picker and a user interface of a device associated with the user to display the response to the message.

12. The computer program product of claim 11, wherein the instructions further cause the processor to perform steps comprising:
receiving, over time from the device associated with the user and via the network, chat data exchanged between the device associated with the user and one or more devices of one or more pickers associated with the online system;
receiving, over time from the device associated with the user and via the network, order data with information about a plurality of orders placed by the user at the online system; and
including the chat data and the order data into the prompt for input into the selected LLM as the first data related to the user.

13. The computer program product of claim 11, wherein the instructions further cause the processor to perform steps comprising:
retrieving, from a database of the online system, aggregated chat data exchanged over time between a plurality of devices associated with the cluster of users and a plurality of devices of pickers associated with the online system;
retrieving, from the database, aggregated order data with information about a plurality of orders placed over time by the cluster of users at the online system; and
including the aggregated chat data and the aggregated order data into the prompt for input into the selected LLM as the second data related to the cluster of users.

14. The computer program product of claim 11, wherein the instructions further cause the processor to perform steps comprising:
placing, based on at least one of chat data exchanged over time between the device associated with the user and one or more devices of one or more pickers associated with the online system, information about item replacements associated with the user, or information about satisfaction of the user with a collection of pickers associated with the online system, the user into the cluster of users; and
generating the identification of the user placed into the cluster of users.

15. The computer program product of claim 11, wherein the instructions further cause the processor to perform steps comprising:
tuning, based on at least one of chat data exchanged over time between the device associated with the user and one or more devices of one or more pickers associated with the online system or order data with information about a plurality of orders placed by the user at the online system, the LLM to have the persona of the user.

16. The computer program product of claim 11, wherein the instructions further cause the processor to perform steps comprising:
tuning, based on at least one of aggregated chat data exchanged over time between a plurality of devices associated with the cluster of users and a plurality of devices of pickers associated with the online system or aggregated order data with information about a plurality of orders placed over time by the cluster of users at the online system, the LLM to have the persona of the user.

17. The computer program product of claim 11, wherein the instructions further cause the processor to perform steps comprising:
receiving, from the device associated with the user and via the network, data with information about a level of satisfaction of the user in relation to the response to the message from the picker generated by the selected LLM on behalf of the user; and
re-tuning the selected LLM based at least in part on the received data.

18. The computer program product of claim 11, wherein the instructions further cause the processor to perform steps comprising:
receiving, from the device associated with the user and via the network, a message entered by the user via the user interface of the device associated with the user upon viewing the response generated by the selected LLM; and
re-tuning the selected LLM based at least in part on the received message entered by the user.

19. The computer program product of claim 11, wherein the instructions further cause the processor to perform steps comprising:
introducing a variation to the response generated by the selected LLM to generate a modified response to the message from the picker on behalf of the user;
causing the user interface of the device associated with the user to further display the modified response;
receiving, from the device associated with the user and via the network, a message entered by the user via the user interface of the device associated with the user upon viewing the modified response; and
re-tuning the selected LLM based at least in part on the received message entered by the user.

20. A computer system comprising:
a processor; and
a non-transitory computer-readable storage medium having instructions that, when executed by the processor, cause the computer system to perform steps comprising:
receiving, from a device of a picker associated with an online system and via a network, a message related to fulfillment of an order placed by a user of the online system;
detecting a threshold amount of time elapsed from the reception of the message without the user responding to the message;
responsive to detecting the elapsed threshold amount of time, selecting, based on an identification of the user, a large language model (LLM) from a set of LLMs, the selected LLM associated with a cluster of users of the online system including the user and tuned to have a persona of the user that is common to the cluster of users;
generating a prompt for input into the selected LLM, the prompt including the message from the picker, first data related to the user, second data related to the cluster of users, and a request for generating a response to the message from the picker;
requesting the selected LLM to generate, based on the prompt input into the selected LLM, the response to the message from the picker on behalf of the user; and
causing a user interface of the device of the picker and a user interface of a device associated with the user to display the response to the message.
